(19) United States
(12) Patent Application Publication
(10) Pub. No.: US 2015/0298420 A1
(43) Pub. Date: Oct. 22, 2015

(54) METHOD FOR EMBOSSING A MULTI-PLY PAPER PRODUCT AND AN EMBOSSED MULTI-PLY PAPER PRODUCT

(71) Applicant: SCA HYGIENE PRODUCTS AB, Göteborg (SE)

(72) Inventors: Susanne GUNGNER, Alvangen (SE); Sofia HODOSSY, Torslanda (SE); Martin STENBERG, Vastra Frolunda (SE)

(73) Assignee: SCA Hygiene Products AB, Goteborg (SE)

(21) Appl. No.: 14/443,240

(22) PCT Filed: Nov. 16, 2012
(86) PCT No.: PCT/SE2012/051270

§ 371 Date: May 15, 2015

(51) Int. Cl. B31F 1/07; D21H 27/40; D21H 27/02; B32B 3/30; B32B 29/00

(52) U.S. Cl. CPC B31F 1/07; B32B 3/30; B32B 29/005; D21H 27/02; D21H 27/40; B31F 2201/0733; B31F 2201/0761; B31F 2201/0774

(57) ABSTRACT

A method for embossing and laminating a multi-ply tissue paper product, wherein first and second webs each including at least one ply of tissue paper are separately embossed with a background embossing pattern by first and second embossing rolls in a first embossing station and the first and second webs are subsequently laminated in a tip-to-tip relationship to form a laminated multi-ply web. The laminated first and second webs are then embossed with a decorative embossing pattern by a third embossing roll in a second embossing station from only one side of the laminated web against a smooth backing roll. A multi-ply tissue product produced by the method and wherein the thickness of the multi-ply web will be substantially the same in areas that are embossed with the decorative embossing pattern as in areas that are embossed only with the background embossing pattern.

### TECHNICAL FIELD

The present invention refers to a method for embossing and laminating a multi-ply tissue paper product, wherein first and second plies, each comprising at least one ply of tissue paper, are embossed by a background pattern and laminated in a tip-to-tip relationship. The invention also refers to an embossed multi-ply tissue paper product.

### BACKGROUND OF THE INVENTION

It is very common to laminate two or more tissue paper plies in order to produce the final tissue product. Herewith a more flexible and softer tissue product is obtained as compared to if one single ply with a corresponding thickness and basis weight had been produced as for the laminated product. The absorbent capacity and the bulk are moreover improved.

The lamination of two or more tissue plies is often made by means of gluing. A mechanical embossing of the plies is also often performed before they are glued together. It is further known to laminate two plies only by means of a mechanical embossing, at which a mechanical joining of the plies occurs in the embossing sites.

Through for example EP-A-796 727 it is known to first emboss two paper plies in a three dimensional structure with alternating raised and recessed portions, after which glue is applied to one of the plies and the two plies are joined in a press nip between two embossing rolls, so that the raised portions of the respective embossed plies are glued to each other in a so called tip-to-tip relationship.

In WO 95/08671 there is enclosed an example of so called nested embossing, in which the two individually embossed plies are combined and joined with the raised portions of one ply nesting into the recessed portions of the opposite ply.

Often there is a desire to emboss the tissue product with a second decorative pattern in addition to the background embossing pattern.

EP-A-570579 discloses a multiply tissue product comprising at least two sheets and comprising first and second embossing patterns with different density and embossing height. The sheets may be laminated tip-to-tip. The second embossment pattern, which can be seen as the more dense background pattern, seems to be a pre-embossment made on the separate sheets and lamination tip-to-tip occurs in the less dense decorative pattern.

EP-A-1236830 discloses two different embossing patterns with a tip-to-tip embossing pattern and an additional embossing pattern, that does not increase the bulk of the tissue. This additional embossing pattern appears in both plies and is arranged in a “nested” configuration.

EP-A-1525977 discloses a method for embossing a multi-ply tissue product with a background pattern and a decorative pattern. The more dense background pattern is a pre-embossment made on the separate sheets. Lamination of the pre-embossed sheets occurs by glue application subsequently to embossing the combined plies by the decorative pattern.

EP-A-797705 also discloses a tissue product embossed with two embossment patterns, one more dense background pattern and a decorative pattern. A two-ply product is disclosed comprising a pair of sheets pre-embossed with the background pattern and laminated tip-to-tip by the decorative pattern.

Different embossment patterns may cause problem with different thicknesses of the tissue product in different areas, which may cause wrinkles in the product and problems in the conveyors and packaging machines. For example for tissue products that are delivered as folded products, such as paper towels, table napkins and the like, and intended to be placed in a dispenser, different thicknesses of the product in different areas will cause problems in loading the dispenser and during dispensing. The decorative pattern is often arranged along the edges of the product, and having the edges of the product thicker than the rest of the product will result in an uneven pile of folded products, which is undesired.

### SUMMARY OF THE INVENTION

The object of the present invention is to provide a method for embossing and laminating a multi-ply tissue paper product, wherein both a first background embossing pattern and a second decorative embossing is provided and wherein the tissue product has an even thickness over its area. According to the method first and second webs each comprising at least one ply of tissue paper are separately embossed with a background embossing pattern by first and second embossing rolls in a first embossing station and are subsequently laminated in a tip-to-tip relationship. The laminated first and second webs are embossed with a decorative embossing pattern by a third embossing roll in a second embossing station from only one side of the laminated web against a smooth backing roll.

Glue may be applied to embossed raised tips of at least one of the first and second embossed webs prior to laminating them

Said smooth backing roll may be a steel roll or a rubber roll, said rubber roll having a hardness between 50 and 90 shore according to ASTM D2240.

The background embossing pattern may be applied over the entire surface area of the multi-ply tissue web and the decorative embossing pattern may be applied over only part of the surface area of the multi-ply web.

The decorative embossing pattern may be applied along edges of a multi-ply tissue paper product produced from said multi-ply web while a central part of said product may be free from the decorative embossing pattern.

The first and second webs may be laminated in a tip-to-tip relationship in a lamination nip between said first and second embossing rolls.

The invention further refers to a multi-ply tissue paper product comprising first and second webs each comprising at least one ply of tissue paper, said first and second webs being separately embossed with a background embossing pattern over the entire surface area of the tissue product and laminated in a tip-to-tip relationship, said multi-ply tissue product further being embossed with a decorative embossing pattern over only a part of the surface area of the tissue product, while the decorative embossing pattern is absent in other surface areas of the tissue product, wherein the decorative embossing pattern is embossed from only one side of the tissue product and the tissue product has an even thickness over its entire surface area, wherein those parts of the tissue product that are embossed with the decorative embossing pattern has a thickness that differs only ±5%, preferably only ±2%, from the thickness of those parts of the tissue product that are embossed only with the background embossing pattern

Said decorative embossing pattern may be a continuous pattern extending over part or parts of the tissue product.

Said decorative embossing pattern may extend along at least one edge of the tissue product, while the decorative embossing pattern is absent in a central area of the tissue product.

Alternatively said decorative embossing pattern may comprise a plurality of discrete spaced-apart embossment areas.

Said tissue product may be a folded product forming part of a pile of folded tissue products.

### DEFINITIONS

### Tissue Paper

A tissue paper is defined as a soft absorbent paper having a basis weight below 65 g/m² and typically between 10 and 50 g/m². Its density is typically below 0.60 g/cm³, preferably below 0.30 g/cm³ and more preferably between 0.08 and 0.20 g/cm³.

The present invention refers to all types of tissue paper. The tissue paper may be creped or non-creped. The creping may take place in wet or dry condition. It may further be foreshortened by any other methods, such as so called rush transfer between wires.

The fibers contained in the tissue paper are mainly pulp fibers from chemical pulp, mechanical pulp, thermo mechanical pulp, chemo mechanical pulp and/or chemo thermo mechanical pulp (CTMP). The fibers may also be recycled fibers. The tissue paper may also contain other types of fibers enhancing e.g. strength, absorption or softness of the paper. These fibers may be made from regenerated cellulose or synthetic material such as polyolefins, polyesters, polyamides etc.

### Ply

A paper comes out from the paper machine as a single-ply paper sheet, which later in the converting process can be combined with other plies by a lamination process, such as gluing and or embossing, to form a multi-ply material. A single ply may comprise one, two or more layers, for example obtained by using a multi-layered headbox, by forming the web layers on top of each other in a sequential mode, or by forming each layer in a separate forming unit before couching the layers together in the paper machine while still in a wet condition.

### BRIEF DESCRIPTION OF THE DRAWINGS

The invention will in the following be closer described with reference to an embodiment shown in the accompanying drawings.

FIG. 1 shows a schematic side view of a device for performing the method according to one embodiment of the invention.

FIG. 2 is a plan view of a laminated tissue product comprising a background embossment pattern and a decorative edge embossment pattern.

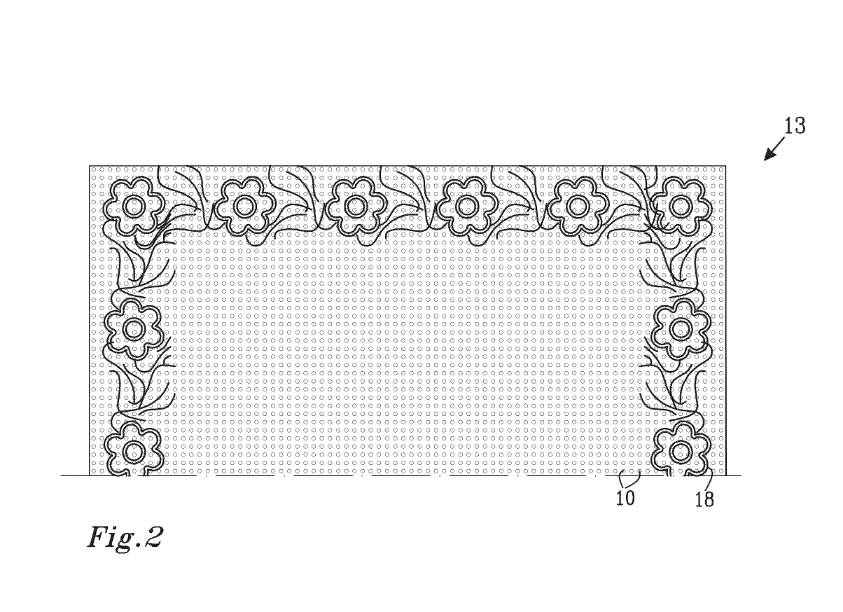

FIG. 3 is a cross-sectional and perspective view of the laminated tissue product according to FIG. 2.

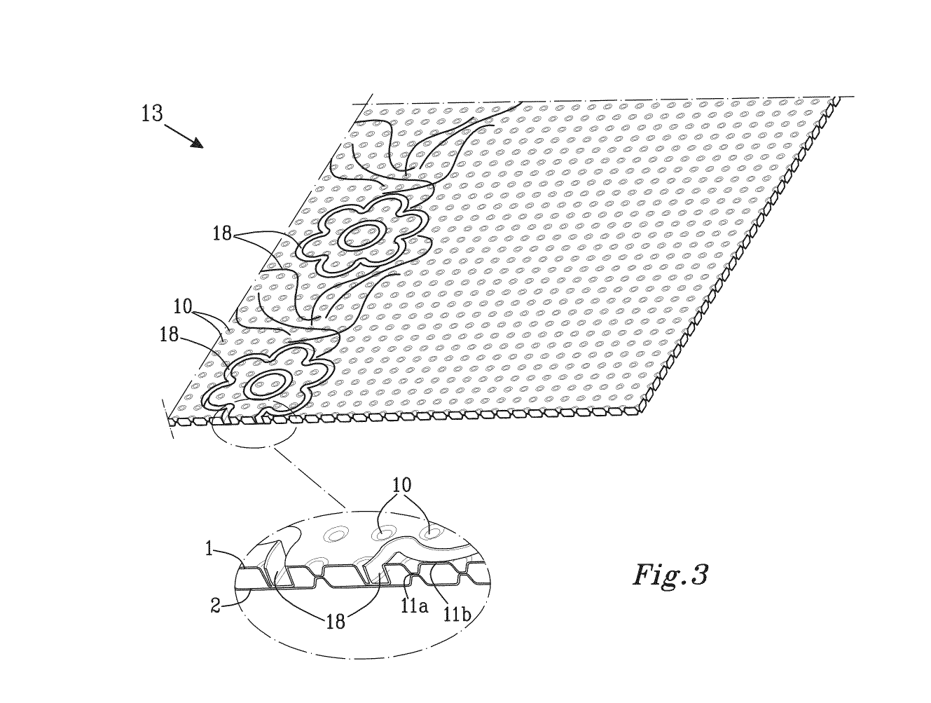

### DETAILED DESCRIPTION OF AN EMBODIMENT

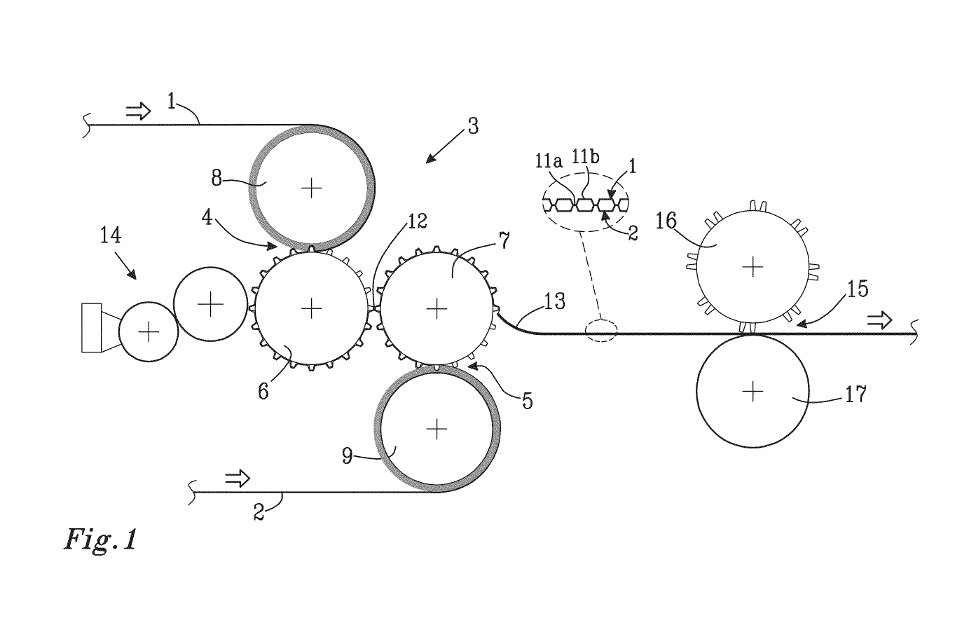

FIG. 1 shows a device for producing a multi-ply tissue paper. First and second paper webs 1 and 2, each comprising one or more plies of tissue paper, are embossed in a first embossing station 3 comprising first and second embossing units 4 and 5. The first and second embossing unit 4 and 5 each comprises an embossing roll 6 and 7 and a rubber backing roll 8 and 9, respectively. The first and second embossing units 4 and 5 match each other and emboss a background pattern 10 in the first and second paper webs 1 and 2, respectively. This background pattern 10 is a three-dimensional pattern comprising alternating raised portions (tips) 11a and recessed portions 11b. It may be a relatively dense micro-embossing pattern having a density of between 20 and 70 embossment dots per cm². The embossment height, measured as the engraving depth of the first and second embossing rolls 6 and 7 may be in the range 0.5 and 1.5 mm.

The background pattern 10 may be embossed over the entire surface of the webs 1 and 2.

A lamination nip 12 is formed between the matched embossing rolls 6 and 7 to laminate the first and second webs 1 and 2 in a tip-to-tip relation to form a multi-ply web 13.

Glue is applied from a glue application station 14 to the raised tips of the first embossed paper web 1 while this resides on the first embossing roll 6 and before lamination to the second embossed paper web 2.

The raised tips 11a of the embossed webs 1 and 2 will adhere to one another as a result of glue application and lamination. By applying glue only to the raised tips 11a of the web 1 spot-bonding joins the two webs 1 and 2 without unduly stiffening the multi-ply web 13. The recessed portions 11b of the two webs 1 and 2 remain spaced apart from one another resulting in a high bulk of the laminated web 13.

After lamination the multi-ply web 13 is embossed in a second embossing station 15 comprising a third embossing roll 16 and a smooth backing roll 17. The second embossing station 15 provides a decoration embossing 18 from only one side of the multi-ply web 13. The decoration embossing 18 may be over only part of the surface of the web or over the entire surface. For example if the multi-ply web will be converted into folded products, such as paper towels, table napkins and the like, a decorative embossing may be provided only along the edges of such a product. This may also apply for a roll product.

The decorative embossing 18 may form a continuous embossment pattern, for example extending along at least one edge of the tissue product. Alternatively the decorative embossing 18 may comprise at least one discrete embossment area or a plurality of discrete spaced-apart embossed areas. Such discrete embossment area or areas may be located anywhere on the surface of the tissue product, for example in at least one corner of the product, in the central part or adjacent at least one edge of the product. The decorative embossing pattern may be any kind of pattern such as geometrical figures, decorative figures, logotypes, text, letters etc.

The smooth backing roll 17 may be a steel roll or a relatively hard rubber roll, wherein the rubber roll should have a hardness in the range 50 to 90 shore according to ASTM D2240. It is important that the backing roll will resist impression of the laminated web into the surface of the backing roll during embossing. Thus the decorative embossing pattern will extend through the entire thickness of the laminated multi-ply web 13, but will not protrude at all or only insignificantly protrude on the side of the web which has faced the backing roll 17. The thickness of the multi-ply web 13 will therefore remain substantially the same in the areas that are embossed with the decorative embossing pattern 18 as in the areas that are only embossed with the background embossing pattern 10. This is an advantage especially for products having a decorative pattern only in parts of it surface, for example along the edges, and wherein it is desirable that the product should have an even thickness over its entire surface. Especially for folded tissue products that are piled for example in a dispenser an even thickness is highly desired. Also for roll products having an edge embossing it is desirable that the thickness should be the same over the surface of the paper web.

It is preferred that the thickness of the multi-ply web differs not more than 5%, preferably not more than 2%, in the areas that are embossed with the decorative embossing pattern 18 as compared to the areas which are embossed only with the background embossing pattern 10.

Tests have been made by separately embossing two tissue paper plies with basis weight 2×16.5 gsm and having a background embossing pattern 10 having a density of 40 embossment dots per cm². The embossment dots had a diamond shape. The engraving depth of the background embossment pattern was 0.8 mm. Glue was applied to the tips of the embossment dots of one ply and the plies were laminated tip-to-tip to form a multi-ply web.

A decorative pattern 18 was embossed into one side of the multi-ply web by a steel embossing roll against a smooth rubber roll having a hardness of 85 shore. Two decorative patterns I and II with different engraving depths 0.8 and 1.4 mm were tested. The decorative patterns were embossed only over part of the surface area of the multi-ply web. For the decorative pattern I the multi-ply web had a thickness that was about 1.2% less in the areas embossed with the decorative embossment pattern as compared to the areas that were embossed only with the background pattern. For the decorative pattern II the thickness was about 0.25% less in the areas embossed with the decorative embossment pattern 18 as compared to the areas that were embossed only with the background pattern 10.

The tissue product according to the invention has an even flexibility and drapability over its surface area due to the even glue lamination in the background embossment pattern extending over the entire surface of the tissue product. No additional glue is applied in the decorative embossment pattern 18.

1. A method for embossing and laminating a multi-ply tissue paper product, the method comprising:
separately embossing first and second webs each comprising at least one ply of tissue paper with a background embossing pattern with first and second embossing rolls in a first embossing station,
subsequently laminating the first and second webs in a tip-to-tip relationship to form a laminated multi-ply web,
embossing the laminated multi-ply web with a decorative embossing pattern by with a third embossing roll in a second embossing station from only one side of the laminated multi-ply web against a smooth backing roll,
wherein the background embossing pattern is applied over the entire surface area of the multi-ply web and the decorative embossing pattern is applied over only part of the surface area of the multi-ply web.

2. A method as claimed in claim 1, wherein glue is applied to embossed raised tips of at least one of the first and second embossed webs prior to laminating them.

3. A method as claimed in claim 1, wherein the smooth backing roll is a steel roll or a rubber roll, said rubber roll having a hardness between 50 and 90 shore according to ASTM D2240.

4. A method as claimed in claim 1, wherein the decorative embossing pattern is applied along edges of a multi-ply tissue paper product produced from said multi-ply web while a central part of said product is free from the decorative embossing pattern.

5. A method as claimed in claim 1, wherein the first and second webs are laminated in the tip-to-tip relationship in a lamination nip between said first and second embossing rolls.

6. A multi-ply tissue paper product comprising first and second webs each web comprising at least one ply of tissue paper, said first and second webs being separately embossed with a background embossing pattern over the entire surface area of the tissue product and laminated in a tip-to-tip relationship, said multi-ply tissue product further being embossed with a decorative embossing pattern over only a part of the surface area of the tissue product, while the decorative embossing pattern is absent in other surface areas of the tissue product,
wherein the decorative embossing pattern is embossed from only one side of the tissue product,
wherein the tissue product has an even thickness over its entire surface area,
wherein those parts of the tissue product that are embossed with the decorative embossing pattern has a thickness that differs only ±5%, from the thickness of those parts of the tissue product that are embossed only with the background embossing pattern.

7. A multi-ply tissue paper product as claimed in claim 6, wherein said decorative embossing pattern is a continuous pattern extending over part or parts of the tissue product.

8. A multi-ply tissue paper product as claimed in claim 6, wherein said decorative embossing pattern extends along at least one edge of the tissue product, while the decorative embossing pattern is absent in a central area of the tissue product.

9. A multi-ply tissue paper product as claimed in claim 6, wherein said decorative embossing pattern comprises at least one discrete embossment area.

10. A multi-ply tissue product as claimed in claim 9, wherein said decorative embossing pattern comprises a plurality of discrete spaced-apart embossment areas.

11. A multi-ply tissue paper product as claimed in claim 6, wherein said tissue product is a folded product forming part of a pile of folded tissue products.

12. A multi-ply tissue paper product as claimed in claim 6, wherein those parts of the tissue product that are embossed with the decorative embossing pattern has a thickness that differs only ±2%, from the thickness of those parts of the tissue product that are embossed only with the background embossing pattern.
